(19) United States
(12) Patent Application Publication
(10) Pub. No.: US 2026/0138472 A1
(43) Pub. Date: May 21, 2026

(54) CHARGING CABLE FOR VEHICLE CHARGER

(71) Applicant: TOYOTA JIDOSHA KABUSHIKI KAISHA, Toyota-shi (JP)

(72) Inventor: Yuya OMORI, Miyoshi-shi (JP)

(73) Assignee: TOYOTA JIDOSHA KABUSHIKI KAISHA, Toyota-shi (JP)

(21) Appl. No.: 19/273,630

(22) Filed: Jul. 18, 2025

(30) Foreign Application Priority Data
Nov. 21, 2024 (JP) 2024-202936

(51) Int. Cl. B60L 53/18; H01B 7/282

(52) U.S. Cl. CPC B60L 53/18; H01B 7/2825

(57) ABSTRACT

A charging cable for a vehicle charger includes a core wire and a coating that covers a periphery of the core wire. The coating includes a surface having an uneven structure. Cutout portions cut in a direction from the surface toward the core wire are regularly provided in the coating.

### CROSS-REFERENCE TO RELATED APPLICATION

This application claims priority to Japanese Patent Application No. 2024-202936 filed on Nov. 21, 2024. The disclosure of the above-identified application, including the specification, drawings, and claims, is incorporated by reference herein in its entirety.

### BACKGROUND

### 1. Technical Field

The present disclosure relates to a charging cable for a vehicle charger.

### 2. Description of Related Art

In the related art, a wire (cable) including a core wire and an insulating coating covering the core wire is known, as disclosed in Japanese Unexamined Patent Application Publication No. 2019-012610 (JP 2019-012610 A).

### SUMMARY

In a charging cable of a vehicle charger, efficient dissipation of heat generated in a core wire is desired.

The present disclosure provides a charging cable for a vehicle charger having excellent heat dissipation properties.

A charging cable for a vehicle charger according to the present disclosure includes:
a core wire; and
a coating that covers a periphery of the core wire.
   The coating includes a surface having an uneven structure.
   Cutout portions cut in a direction from the surface toward the core wire are regularly provided in the coating.

With such a configuration, the uneven structure of the surface and the cutout portions regularly provided in the coating enable an increase in the surface area of the coating compared to a configuration that lacks either or both of the uneven structure and the cutout portions. Therefore, the charging cable has excellent heat dissipation properties for heat generated in the core wire compared to a charging cable having a configuration that lacks either or both of the uneven structure and the cutout portions.

The cutout portions may be arranged along an outer peripheral direction of the coating and an extending direction of the core wire.

With such a configuration, the surface area of the coating can be increased compared to a configuration in which the cutout portions are not arranged along the outer peripheral direction of the coating and the extending direction of the core wire. Therefore, the charging cable has excellent heat dissipation properties compared to a charging cable having a configuration in which the cutout portions are not arranged along the outer peripheral direction of the coating and the extending direction of the core wire.

The cutout portions may be continuous in the outer peripheral direction of the coating and the extending direction of the core wire.

With such a configuration, the surface area of the coating can be increased compared to a configuration in which the cutout portions are not continuous in the outer peripheral direction of the coating and the extending direction of the core wire. Therefore, the charging cable has excellent heat dissipation properties compared to a charging cable having a configuration in which the cutout portions are not continuous in the outer peripheral direction of the coating and the extending direction of the core wire.

The shapes of cuts defined by the cutout portions may have a honeycomb shape as viewed from the surface.

With such a configuration, the strength of the coating can be increased compared to when the shapes of the cuts are not in the honeycomb shape.

The uneven structure may be a honeycomb structure including a plurality of recessed portions.

A separation distance between centers of adjacent recessed portions among the recessed portions is 10 μm or more and 100 μm or less.

With such a configuration, the surface of the coating exhibits a superhydrophobic effect.

According to the present disclosure, the charging cable has excellent heat dissipation properties.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing a power supply device for an electrified vehicle;

FIG. 2 is a cross-sectional view taken along line II-II of FIG. 1;

FIG. 3 is a view showing a surface of a coating;

FIG. 4 is an enlarged view of a cross section shown in FIG. 2;

FIG. 5 is a view showing a state when a charging cable is bent; and

FIG. 6 is a view for describing another surface of the coating.

### DETAILED DESCRIPTION OF EMBODIMENTS

Hereinafter, an embodiment of the present disclosure will be described with reference to the drawings. In the following description, the same reference numerals are given to the same members. The names and functions thereof are also the same. Therefore, detailed descriptions thereof will not be repeated.

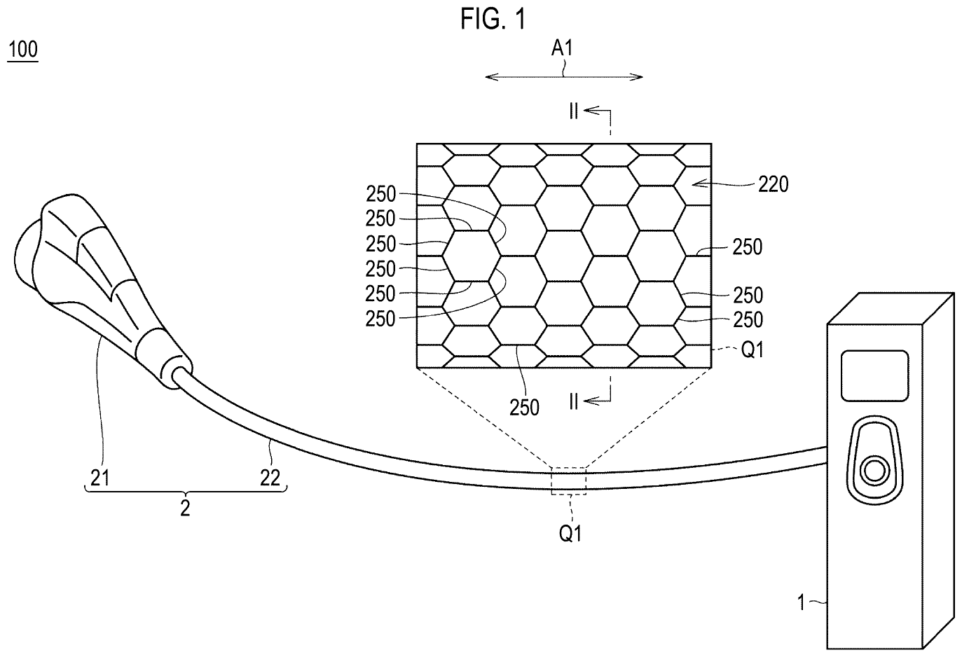

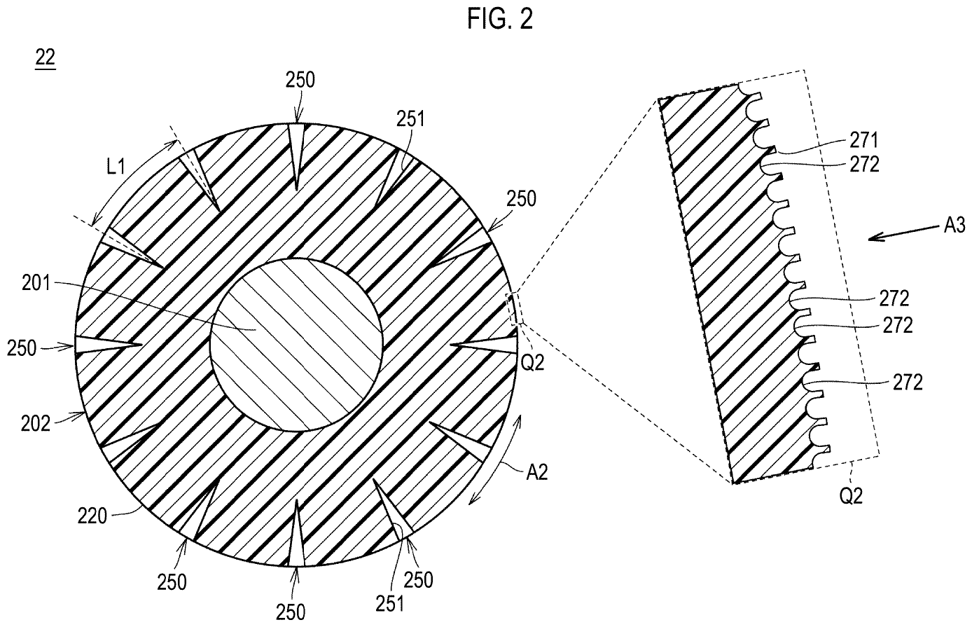

FIG. 1 is a view showing a power supply device for an electrified vehicle. FIG. 2 is a cross-sectional view taken along line II-II of FIG. 1. The electrified vehicle is a hybrid electric vehicle that can travel using at least one of the powers of the motor and the engine, or an electric vehicle that travels by a driving force obtained from electrical energy.

As shown in FIG. 1, the power supply device 100 includes an external power source 1 and a charger 2. The charger 2 includes an external power supply connector 21 and a charging cable 22. The charger 2 is connected to the external power source 1. The external power supply connector 21 is connected to the external power source 1 via the charging cable 22. The external power supply connector 21 is also referred to as a “charging gun” or a “charging link”. In FIG. 1, a partial region Q1 of the surface 220 (FIG. 2) of the charging cable 22 is enlarged and shown. The region Q1 is any region on the surface 220.

As shown in FIG. 2, the charging cable 22 includes a core wire 201 and a coating 202 that covers a periphery of the core wire. The core wire 201 is an electric wire. The core wire 201 is, for example, a single wire or a stranded wire. The coating 202 is an insulating coating. The coating 202 includes a surface 220. The surface 220 is an outer exposed surface opposite to the core wire 201. The surface 220 is a surface that comes into contact with the ground or the like when the charger 2 is in use. The coating 202 is made of rubber in the present example. The coating 202 is preferably made of a material having high water repellency.

Since oil bleed leaks from the rubber, the surface 220 has hydrophobic properties. The surface 220 is not limited to this, and it is preferable that the surface 220 is coated with a hydrophobic coating.

As shown in FIGS. 1 and 2, cutout portions 250 cut in a direction from the surface 220 toward the core wire 201 are periodically provided in the coating 202. Each of the cutout portions 250 is arranged along the outer peripheral direction of the coating 202 (the direction of the arrow A2 in FIG. 2) and the extending direction of the core wire 201 (the direction of the arrow A1 in FIG. 1). Specifically, each of the cutout portions 250 is continuous in the outer peripheral direction of the coating 202 and the extending direction of the core wire 201. More specifically, as shown in FIG. 1, the shape of the cutout defined by each of the cutout portions 250 has a honeycomb shape as viewed from the surface 220 of the coating 202.

With reference to FIG. 2, a separation distance L1 of each of the cutout portions 250 in the outer peripheral direction (direction A2 of FIG. 2) of the coating 202 is, for example, 1 mm or more and 10 mm or less. In the present example, the width (opening width) of each cut decreases as it approaches the core wire 201. As each of the cutout portions 250 is provided in the coating 202, the surface 251 is provided on the inner side of the coating 202 relative to the surface 220. The surface 251 extends at least in a direction of the core wire 201 from the surface 220.

In FIG. 2, a cross section Q2 of a part of the region of the coating 202 is enlarged and shown. Specifically, in FIG. 2, a cross section Q2 of a location included in the hexahedral portion (see FIG. 1) partitioned by each of the cutout portions 250 is enlarged and shown. The location is any location including the surface 220.

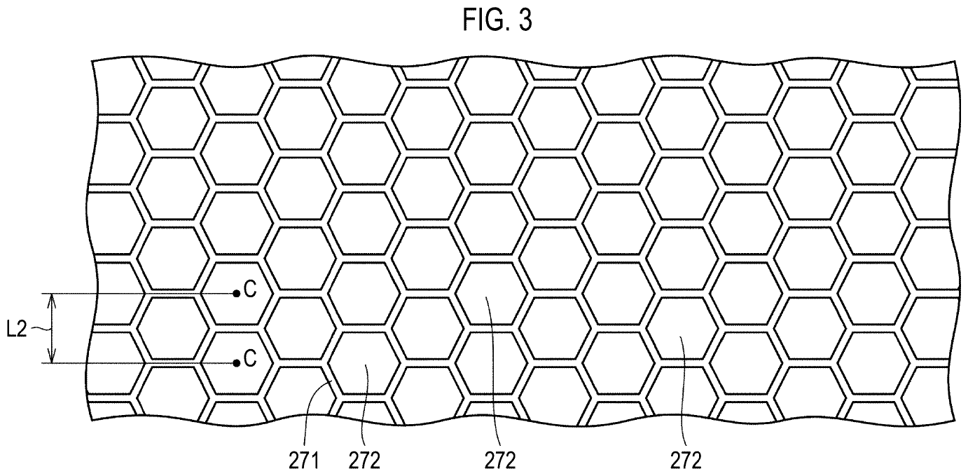

FIG. 3 is a view of the surface 220 of the coating 202 as viewed in the direction of the arrow A3 in FIG. 2. As shown in FIGS. 2 and 3, the surface 220 has an uneven structure. In the present example, the surface 220 includes one protrusion portion 271 and a plurality of recessed portions 272. The recessed portions 272 are separated from each other by the protrusion portion 271. The uneven structure of the surface 220 is provided with the protrusion portion 271 and the recessed portions 272. The surface 220 may have an uneven structure provided with a plurality of protrusion portions and a plurality of recessed portions, without being limited to the above.

As described above, the coating 202 is subjected to surface treatment to have an uneven structure. Specifically, the surface 220 of the coating 202 has a structure (uneven structure) in which an uneven shape is provided along the outer peripheral direction of the coating 202 and the extending direction of the core wire 201. In other words, the surface 220 is subjected to uneven processing. The surface 220 is processed to have an uneven shape. The surface 220 has an uneven shape. Specifically, the surface 220 is subjected to fine uneven processing.

As shown in FIG. 3, the uneven structure of the surface 220 is a honeycomb structure including a plurality of recessed portions 272. Each of the recessed portions 272 has a hexagonal shape as viewed from the surface 220. In the present example, the separation distance L2 between the centers C of the adjacent recessed portions 272 among the recessed portions 272 is 10 μm or more and 100 μm or less. The uneven structure of the surface 220 is a micro-order uneven structure.

The protrusion portion 271 is erected from the periphery of each of the recessed portions 272 in the radial direction of the charging cable 22 such that each of the recessed portions 272 has a hexagonal shape. The protrusion portion 271 extends along the outer peripheral direction of the coating 202 and the extending direction of the core wire 201.

As described above, the coating 202 has a honeycomb shape defined by each of the cutout portions 250. Due to the uneven structure described above, the honeycomb shape provided on the surface 220 is smaller than the honeycomb shape defined by each of the cutout portions 250.

As described above, the charging cable 22 includes a core wire 201 and a coating 202 that covers a periphery of the core wire 201. The coating 202 includes a surface 220 having an uneven structure. Cutout portions 250 cut in a direction from the surface 220 toward the core wire 201 are periodically provided in the coating 202.

With such a configuration, the uneven structure of the surface 220 and the cutout portions 250 periodically provided in the coating 202 enable an increase in the surface area of the coating 202 compared to the configuration that lacks either or both of the uneven structure and the cutout portions 250. Therefore, with the charging cable 22, the heat dissipation properties for heat generated in the core wire 201 are excellent compared to the configuration that lacks either or both of the uneven structure and the cutout portions 250.

Each of the cutout portions 250 is arranged along an outer peripheral direction of the coating 202 and an extending direction of the core wire 201. With such a configuration, the surface area of the coating 202 can be increased compared to the configuration in which each of the cutout portions 250 is not arranged along the outer peripheral direction of the coating 202 and the extending direction of the core wire 201. Therefore, with the charging cable 22, the heat dissipation properties are excellent compared to the configuration in which each of the cutout portions 250 is not arranged along the outer peripheral direction of the coating 202 and the extending direction of the core wire 201.

Each of the cutout portions 250 is continuous in the outer peripheral direction of the coating 202 and the extending direction of the core wire 201. With such a configuration, the surface area of the coating 202 can be increased compared to the configuration in which each of the cutout portions 250 is not continuous in the outer peripheral direction of the coating 202 and the extending direction of the core wire 201. Therefore, with the charging cable 22, the heat dissipation properties are excellent compared to the configuration in which the coating 202 and the core wire 201 are not continuous in the outer peripheral direction of the coating 202 and the extending direction of the core wire 201.

The shape of a cut defined by each of the cutout portions 250 has a honeycomb shape as viewed from the surface 220. With such a configuration, the strength of the coating 202 can be increased compared to when the shape of the cut is not the honeycomb shape.

The uneven structure of the surface 220 is a honeycomb structure. A separation distance between the centers C of the adjacent recessed portions 272 among the recessed portions 272 is 10 μm or more and 100 μm or less. With such a configuration, the surface 220 exhibits a superhydrophobic effect.

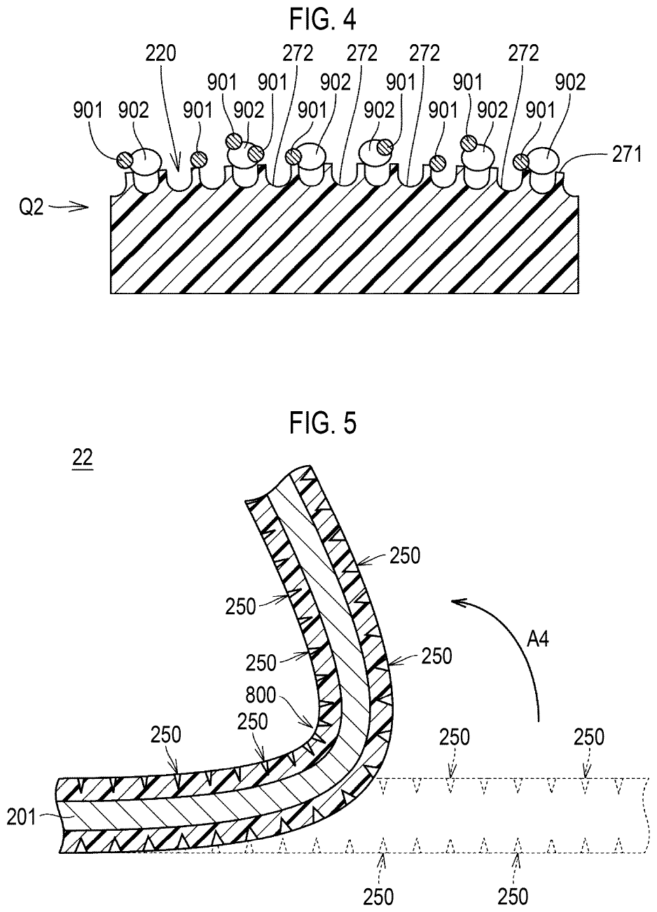

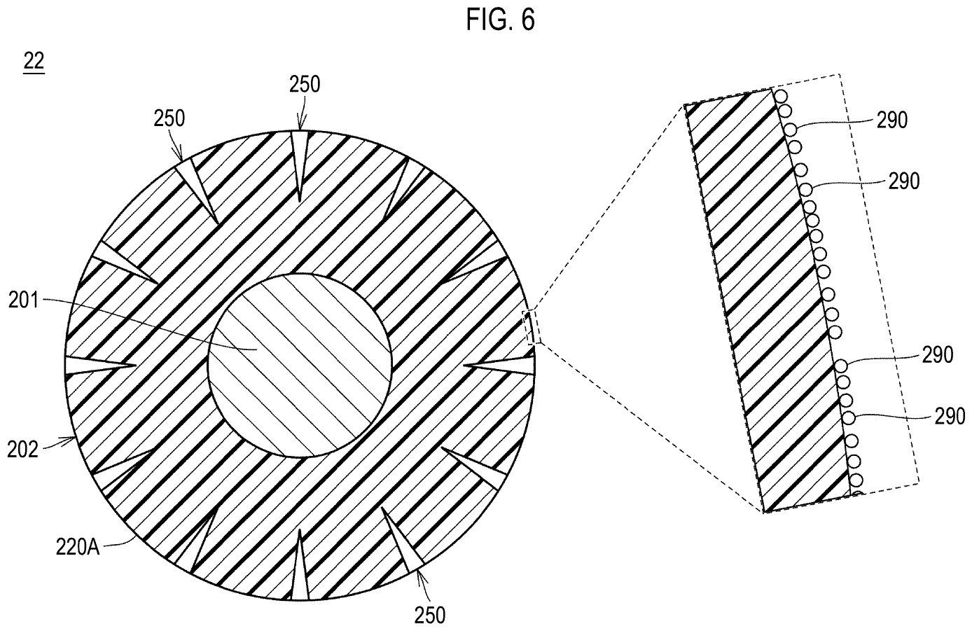

FIG. 4 is an enlarged view of a cross section Q2 shown in FIG. 2. FIG. 5 is a view showing a state when the charging cable 22 is bent. Hereinafter, further advantages of the charging cable 22 will be described based on FIGS. 4 and 5.

As shown in FIG. 4, the dust 901 adheres to the surface 220. Due to rain or the like, water droplets 902 also adhere to the surface 220. As described above, the surface 220 exhibits a superhydrophobic effect. In such a state, when the charger 2 is used, the water droplet 902 falls. Specifically, the charging cable 22 is moved in response to the movement of the external power supply connector 21 when the charger 2 is in use. As a result, the charging cable 22 sways. As a result, the water droplet 902 falls. In this case, the dust 901 also falls by the water droplet 902. In this way, the charging cable 22 is self-cleaned by the falling of the water droplet 902.

As shown in FIG. 5, in a case where the user tries to bend the charging cable 22 in the direction of the arrow A4, the flexibility of the charging cable 22 is improved by each of the cutout portions 250. Specifically, the charging cable 22 has a function like a bellows due to each of the cutout portions 250. Therefore, the charging cable 22 can be made more flexible compared to the configuration without each of the cutout portions 250.

When the humidity is high due to rain or the like, water is accumulated in the cutout portion 250 due to a capillary phenomenon. Even in this case, as the charging cable 22 dries, moisture is drawn up to the surface 220 side. Therefore, each of the cutout portions 250 is self-cleaned. Therefore, even when each of the cutout portions 250 is provided in the coating 202, the hygienic surface of the coating 202 is secured.

### Modification

In the above, the surface 220 of the coating 202 covering the core wire 201 has an uneven structure due to the application of the uneven processing. The uneven structure can be provided by a method described below without relying on the uneven processing.

FIG. 6 is a view for describing the surface 220A of the coating 202. As shown in FIG. 6, the surface 220A has an uneven structure due to the adhesion of a plurality of particles 290. Each of the particles 290 is typically a particle sprayed from a waterproof spray or a water-repellent spray. Even with such a configuration, the same effect as the uneven structure obtained by the uneven processing can be obtained.

The embodiment disclosed this time is to be considered merely illustrative and not restrictive in all respects. The scope of the present disclosure is defined by the terms of the claims, and is intended to include any modifications within the scope and meaning equivalent to the terms of the claims.

What is claimed is:

1. A charging cable for a vehicle charger, the charging cable comprising:
a core wire; and
a coating that covers a periphery of the core wire, wherein:
the coating includes a surface having an uneven structure; and
cutout portions cut in a direction from the surface toward the core wire are regularly provided in the coating.

2. The charging cable according to claim 1, wherein the cutout portions are arranged along an outer peripheral direction of the coating and an extending direction of the core wire.

3. The charging cable according to claim 2, wherein the cutout portions are continuous in the outer peripheral direction of the coating and the extending direction of the core wire.

4. The charging cable according to claim 3, wherein shapes of cuts defined by the cutout portions have a honeycomb shape as viewed from the surface.

5. The charging cable according to claim 4, wherein:
the uneven structure is a honeycomb structure including a plurality of recessed portions; and
a separation distance between centers of adjacent recessed portions among the recessed portions is 10 μm or more and 100 μm or less.
